(19) United States
(12) Patent Application Publication
(10) Pub. No.: US 2020/0005831 A1
(43) Pub. Date: Jan. 2, 2020

(54) SYSTEMS AND METHODS FOR PROCESSING DIGITAL VIDEO

(71) Applicant: Liquid Cinema Inc. Canada, Toronto (CA)

(72) Inventors: Thomas Wallner, Toronto (CA); Franz Hildgen, Toronto (CA)

(21) Appl. No.: 16/023,375

(22) Filed: Jun. 29, 2018

(51) Int. Cl. G11B 27/19; H04N 5/262; H04N 5/272; G11B 27/036

(52) U.S. Cl. CPC G11B 27/19; H04N 5/2628; H04N 5/23238; G11B 27/036; H04N 5/272

(57) ABSTRACT

A computer-implemented method of processing digital video includes, for each of a plurality of selected frames of the digital video: subjecting image data in the frame to scaling to occupy an image region that is smaller than the frame thereby to form at least one non-image region between the image region and the frame boundary; and inserting non-image data into at least one non-image region. A computer-implemented method of processing digital video includes, for each of a plurality of selected frames of the digital video: processing contents occupying one or more predetermined non-image regions of the frame to extract non-image data therefrom; and subjecting an image region of the frame to mapping to expand the image region to a displayable size. Systems and computer-readable media are also disclosed.

### FIELD OF THE INVENTION

The following relates generally to electronic data processing, and more particularly to systems and methods for processing digital video.

### BACKGROUND OF THE INVENTION

A wide variety of computing devices such as gaming consoles, virtual-reality equipment, augmented-reality equipment, mixed-reality equipment, smart televisions, set top boxes, desktop computers, laptops, smartphones, and specialty devices such as iPods, are available to consumers. The computing capabilities of many of these devices can be harnessed by creative content producers to provide very rich, immersive and interactive media content.

For example, filmmakers, digital content creators and technology developers have been developing 360-video capture systems, corresponding authoring tools and compatible media players to create and present interactive and immersive media experiences for a variety of platforms including virtual reality. Such video capture systems include multiple individual but coordinated video cameras positioned in an array in which each camera has a unique position and field of view to collectively capture video that spans 360×180 degrees. Frames of the captured digital video from the video cameras are synchronized and stitched together using image processing algorithms to produce video frames each of which contains 360×180 content. Each of these video frames is typically stored in an equirectangular format, to facilitate straightforward projection onto a geometry such as a spherical mesh for playback.

A user can be provided with the impression that he or she is positioned at the centre of the sphere looking outward towards the captured scenes, in a manner analogous to the position of the cameras during video capture. In addition, the user may be provided with the ability to adjust his or her perspective and field of view, such as by using a mouse on a desktop-style system, a touch-display on a typical smartphone, or actual physical movement using virtual reality headgear (Head Mounted Display, or HMD), in order to face any part of the 360×180 video that is being played back. In this way, the user can “look around” and in any direction will see the respective portions of the film unfolding as it is played back just as one can look around in reality.

Processes for producing digital video from raw content such as that captured by a 360-video capture system are well understood. Specialty software tools are used to stitch together the content from the different camera angles to produce the raw video. Then, the raw video can be edited and spliced with other video, graphic overlays and the like, on a computer workstation using software tools. When the author/editor is satisfied with the content, the digital video is considered “locked,” and post-production tools can be used to convert the locked digital video into a form suitable for transmission, playback and storage using various media players, devices and the like. For example, it is typical to encode raw video into a format such as MP4 using H.264 or H.265 to compress the video so that the overall file in which it is contained is smaller and wieldy for storage and transmission. Encoders are sets of hardware and software that receive the original raw digital video content as input and that output an encoded digital video file. Transcoders are sets of hardware and software that receive an encoded video file and re-encode the file into a different encoded format. Decoders are sets of hardware and software that receive an encoded video file, and extract each frame as pixel data so that the pixel data can be inserted into a memory buffer which can be later stored in a frame buffer for subsequent display by a display device. Together, coders/transcoders and decoders are typically referred to as codecs.

There are challenges to producing content that can be enjoyed on a wide variety of computing devices, systems and platforms. For example, numerous codecs are available. Because of the nature of the algorithms used in codecs and the way decoded frames are buffered prior to display, codecs do not generally enable a playback device such as a media player to know exactly which frame has been decoded. Instead, some codecs produce and expose an elapsed time from which an approximation as to an actual frame number can be derived. As such, due to this nature of compression algorithms and buffering, the playback time indicated by a media player's decoder for a particular frame may not, for example, coincide with the actual playback time that might be indicated by another media player's decoder for the same frame. For example, there may be a disparity on the order of 5 to 10 frames on a 30 frame per second (fps) playback.

When authoring digital videos, an author/editor may wish to add certain events which are to be triggered by a media player during playback. Parameters specifying such events and their exact timing may be stored as metadata in a file associated with the digital video, and be identified according to frame number or playback time. For example, the author/editor may wish to trigger the media player to live-render and display a particular graphical overlay caption or subtitle, to play a sound and/or to launch an interactive event just as a particular frame is displayed. As another example, the author/editor may wish to trigger the media player to play a separate and independent video overlaid atop a 360 video, just as a particular frame of the 360 video is displayed. Such graphical elements, auditory cues, interactive events and videos independent from the 360 video can be very useful to content authors. This is the case because such additional events do not have to be “baked into” the main digital video itself. They can be rendered independently and/or in parallel with the main video, greatly expanding the possible real time interactive nature of the experience during the viewing of such video. It also allows such additional events to be fine-tuned in subsequent productions without requiring re-working of the digital video itself.

Frame-accurate event-triggering is crucial for certain kinds of events. As an example, for digital video that switches between 360-video and traditional non-spherical video segments, a media player must know precisely at which frame to switch from displaying video frames as flat projections to displaying the video frames as spherical projections, and vice versa. When a frame and its projection are not matched, the experience for a user will become jarring and difficult to perceive as realistic. While some media players can extract and provide frame sequence data that may accompany digital video of certain formats, how this may be done, if at all, is not universal across all of the various media players and video formats. As such, content producers are left with a deficiency of control over how the content they have created will ultimately be experienced by a user. Even an approximation of the frame based on playback time as measured by the media player can produce poor results. For a projection switch done even a few frames earlier or later than the frame at which the switch should precisely have happened the small series of mismatched frames can be jarring enough to disturb the user.

It has been proposed to embed visual timecodes as non-image data into the frames themselves to uniquely identify the frames. With this approach, upon decoding and instead of relying on playback time, the media player can process the frames to read the visual timecodes and thereby be aware of exactly which frame has been decoded. However, since such visual timecodes are actually integrated as part of the digital video itself, absent some additional processing the media player will naturally display them along with the rest of the digital video content such that the user will see them. For traditional flat film, where visual timecodes may be positioned in the uppermost or lowermost region of the frame, such additional processing may include the frame being cropped and/or stretched to remove the visual time code, prior to being inserted into a frame buffer for display. Such cropping or minor stretching of a frame of flat film does not distort the frame and the user is typically unaware that anything has been done. However, image cropping does eliminate an entire region of an image.

Furthermore, it is problematic to attempt simply cropping or stretching an equirectangular frame to remove a visual timecode in the same way. Such a modification to an equirectangular frame would manifest itself, upon mapping to a sphere, as significant and noticeable distortion. Because of this, it is difficult to hide a visual timecode in such a frame. The visual timecode may be positioned in the equirectangular frames such that it will be mapped to a position near to the zenith (top) or nadir (bottom) of the sphere. This will cause it to be squeezed and distorted thereby reducing the likelihood that it will be noticed. However, it will still remain as an undesirable and disturbing visual artifact.

When viewing 360 video on a desktop computer, a mobile device or the like, it may be acceptable to programmatically limit the degree of freedom available to the user, so the user is simply unable to adjust his or her field of view to encompass the area where the visual timecode is positioned. However, particularly in the virtual reality context, where the user using a HMD can adjust his or her field of view by physically moving his or her head or body, it is not possible to limit the user's movement physically. Furthermore, in the virtual reality context, masking out the visual timecode would create another visual artifact and would prevent showing the 360-degree sphere in its entirety, greatly detracting from the immersive quality of the medium.

It has been proposed to automatically replace the pixels of a visual timecode, once it has been extracted from the frame, with pixels that better match the surrounding, non-timecode content. However, algorithms for detecting surrounding pixel colours and their intensities for overwriting the timecode pixels generally can produce noticeable visual artifacts. Such algorithms also tend to be processor-intensive, consuming valuable computing resources thereby having a detrimental effect on the playback frame rate. This can be particularly problematic for applications in which a higher frame rate is important for user experience, such as in virtual reality.

United States Patent Application Publication No. 2018/0005447 (Wallner et al.) discloses a computer-implemented method of processing digital video including determining at least one frame region the contents of which would be rendered substantially invisible, were frames of the digital video to be subjected to a predetermined texture-mapping onto a predetermined geometry; and inserting non-image data into at least one selected frame by modifying contents within at least one determined frame region of the selected frame. As stated in Wallner et al., systems and methods disclosed in Wallner et al. enable a digital video creator to pass non-image data through to downstream devices, systems and software such as media players. Because the non-image data is incorporated within the frame, it serves as a platform independent, codec-agnostic and frame-accurate data transport mechanism. Furthermore, positioning and dimensioning the non-image data being incorporated according to an expected mapping keeps the non-image data substantially invisible (i.e., practically unnoticeable or completely invisible) to the user, without the need for stretching or cropping, thereby maintaining the integrity of the image content that is intended to be seen.

Another computer-implemented method disclosed in Wallner et al. pertaining to the activities conducted for processing and then displaying digital video includes, for each of a plurality of frames of the digital video: processing contents in one or more predetermined regions of the frame to extract non-image data therefrom; subjecting the frame to a predetermined texture-mapping onto a predetermined geometry, wherein due to the texture-mapping the contents of the one or more predetermined regions are rendered substantially invisible; and causing the texture-mapped frame to be displayed.

While techniques such as those disclosed in Wallner et al. are useful for incorporating non-image data along with image data into a frame of digital video, and for extracting the non-image data downstream for use during display of the digital video, alternatives are desirable.

### SUMMARY OF THE INVENTION

In accordance with an aspect, there is provided a computer-implemented method of processing digital video, the method comprising for each of a plurality of selected frames of the digital video: subjecting image data in the frame to scaling to occupy an image region that is smaller than the frame thereby to form at least one non-image region between the image region and the frame boundary; and inserting non-image data into at least one non-image region.

In accordance with another aspect, there is provided a computer-implemented method of processing digital video, the method comprising for each of a plurality of selected frames of the digital video: processing contents occupying one or more predetermined non-image regions of the frame to extract non-image data therefrom; subjecting an image region of the frame to scaling thereby to expand the image region to a displayable size.

As compared to other image processing operations such as cropping, conducting scaling to a smaller size (downscaling), such as squeezing, of the image data prior to inserting the non-image data has a benefit of preserving some image data for the whole of the image, rather than discarding entire regions of image data to accommodate non-image data. As compared to other techniques for including non-image data that fully preserve an image in a frame by enlarging the frame boundaries to provide regions for non-image data, with the techniques disclosed herein, standard frame sizes and proportions can be maintained throughout the chain of handling, from capture through to display. Furthermore, by downscaling the image data to form non-image regions, the non-image data to be inserted into the non-image regions does not have to correlate in size and spacing with portions of the image that would be rendered invisible due to the fold-over effect exploited in the above-noted Wallner et al. patent application, were the frames mapped to a predetermined geometry just prior to display. Still further, the techniques disclosed herein for inserting, and downstream extracting, may be employed in a way that is agnostic as to whether or not an image in a frame is intended to be displayed as a flat frame or is to be mapped to a predetermined geometry, such as equirectangular or other forms of spherical media such as cube maps and the like.

In accordance with another aspect, there is provided a processor readable medium embodying a computer program for processing digital video, the computer program comprising program code that for each of a plurality of selected frames of the digital video: subjects image data in the frame to scaling to occupy an image region that is smaller than the frame thereby to form at least one non-image region between the image region and the frame boundary; and inserts non-image data into at least one non-image region.

In accordance with another aspect, there is provided a processor readable medium embodying a computer program for processing digital video, the computer program comprising program code that for each of a plurality of selected frames of the digital video: processes contents occupying one or more predetermined non-image regions of the frame to extract non-image data therefrom; and subjects an image region of the frame to scaling thereby to expand the image region to a displayable size.

In accordance with another aspect, there is provided a system for processing digital video comprising processing structure that, for each of a plurality of frames of the digital video: subjects image data in the frame to scaling to occupy an image region that is smaller than the frame thereby to form at least one non-image region between the image region and the frame boundary; and inserts non-image data into at least one non-image region.

In accordance with another aspect, there is provided a system for processing digital video comprising processing structure that, for each of a plurality of frames of the digital video: processes contents occupying one or more predetermined non-image regions of the frame to extract non-image data therefrom; and subjects an image region of the frame to scaling thereby to expand the image region to a displayable size.

Other aspects and advantages are disclosed herein.

### BRIEF DESCRIPTION OF THE DRAWINGS

Embodiments of the invention will now be described with reference to the appended drawings in which:

FIG. 1 is a flowchart depicting steps in a method, according to an embodiment;

FIG. 2 is a diagram showing an example of image data of a frame of digital video being scaled-down, in particular squeezed, to form a non-image region into which non-image data is inserted prior to sending the digital video downstream;

FIG. 3 is a schematic diagram of a computing system according to an embodiment;

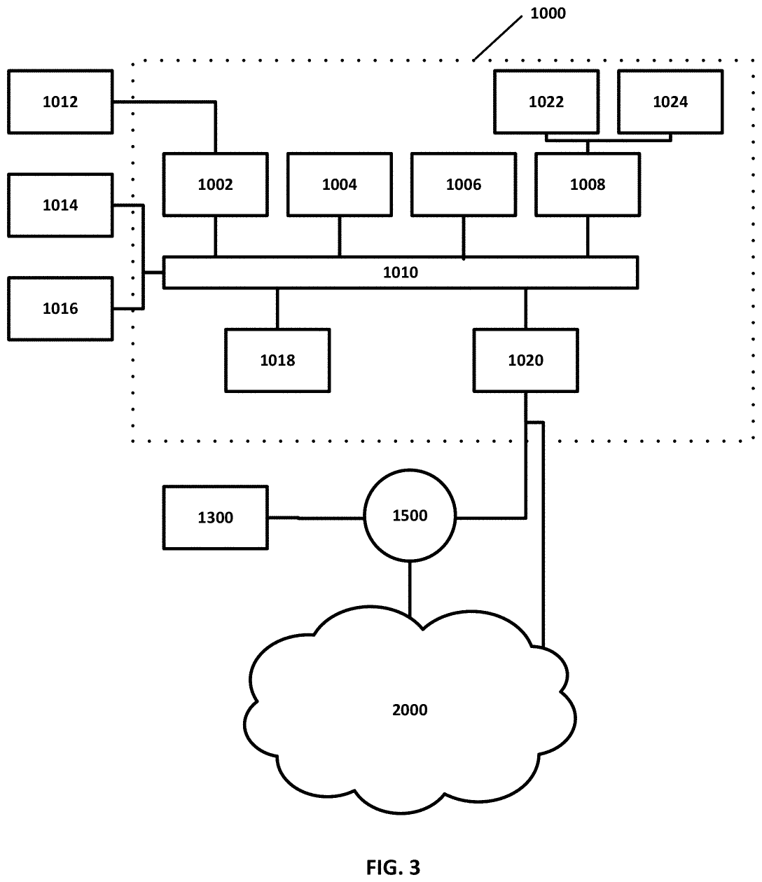

FIG. 4 is a flowchart depicting steps in a method, according to an embodiment;

FIG. 5 is a diagram showing an example of non-image data in a non-image region of a frame of digital video being extracted and then the image data of the frame being scaled-up to expand the image region to a displayable size; and

FIG. 6 is a diagram showing an embodiment of non-image data placed within a predetermined region within a frame.

### DETAILED DESCRIPTION

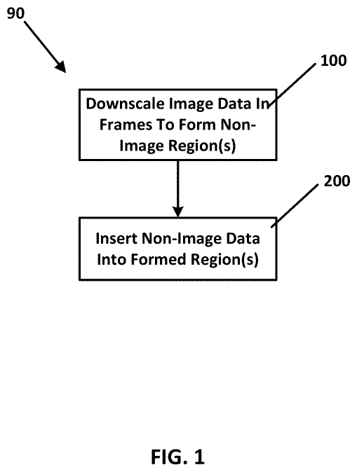

FIG. 1 is a flowchart depicting steps in a process 90 for processing digital video, according to an embodiment. In this embodiment, during process 90, image data in a frame of digital video is scaled-down, in this embodiment squeezed, to be smaller than the frame size thereby to form non-image region(s) in the frame (step 100). Pursuant to the formation of the non-image region(s), non-image data is inserted into the non-image region(s) (step 200).

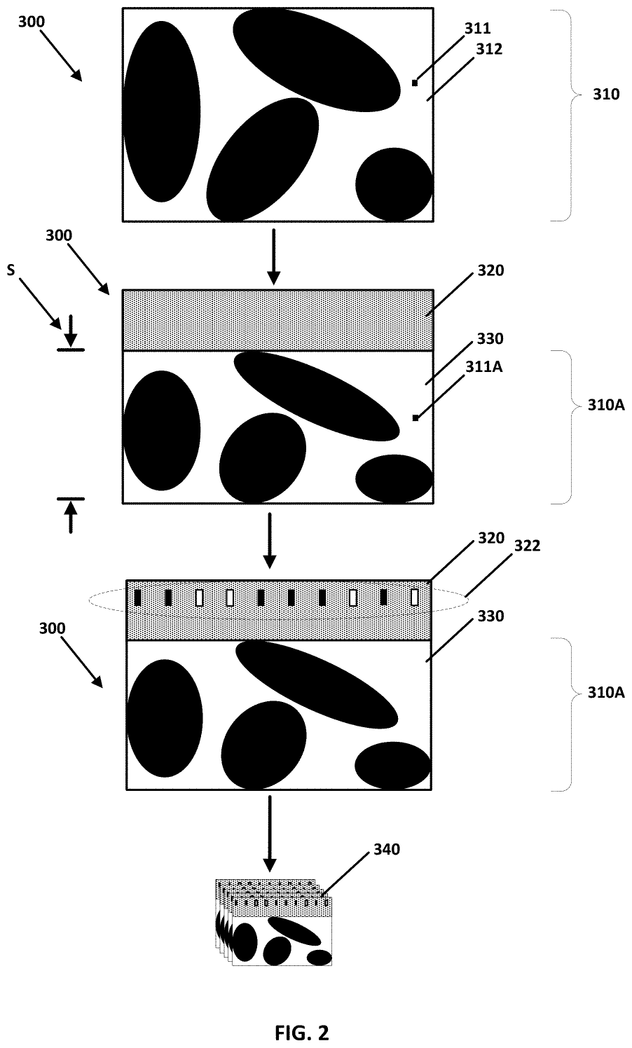

FIG. 2 is a diagram showing an example of image data 310 of a frame 300 in an original image region 312 of digital video being scaled-down, in this embodiment squeezed, S—reduced in size i.e. smaller than the frame without cropping—to form a modified image region 330 and a non-image region 320 that together take up the same area as the original image region 312. In this embodiment, the non-image region 320 is formed between the image region 330 and the frame boundary B, and the squeezed image data 310A occupies the image region 330. In this embodiment, example pixel 311A in the scaled image data 310A has a location in the frame corresponding mathematically to the location of example pixel 311 in the unsealed image data 310 in the frame, based on the height of the non-image region that is formed. For example, for a height h of the non-image region 320 for a vertical squeezing operation, the location of pixel 311A (x′,y′) may be calculated from the location of pixel 311 (x,y) as in Equation 1 below:

$${x}^{′} = x \\ {y}^{′} = \frac{Sy - h}{Sy} y \qquad ( 1 )$$

It will be noted that example pixel 311A may not have the exact same colour/intensity etc. attributes as example pixel 311, but instead its attributes would be derived from the attributes of example pixel 311 and, depending on the method for scaling that is used, derived using attributes of pixels in the neighborhood of example pixel 311 in image data 310.

Pursuant to scaling S, non-image data 322 is inserted into the one non-image region 320. In this embodiment, the non-image data that is inserted into the frames includes a respective frame identifier that uniquely identifies each frame in the digital video. Also, in this embodiment, each frame identifier also identifies the sequential position of each frame in the digital video. As such, the frame identifier may be considered a frame-accurate timecode across all platforms, devices and systems, as distinct from the elapsed time timecode generated by a codec of a particular media player on a particular system that is merely an approximation to the actual frame and thus is not reliably frame-accurate. Furthermore, in this embodiment, each frame in the digital video has a respective frame identifier inserted into it in this manner, so that all frames received by a decoder can, once decoded, be processed in order to extract the frame identifier data instead of relying on the decoder's timecode. Because the frame identifier (and/or any another other non-image data) is incorporated within the frame (i.e., where the pixels are typically located), the combination serves as a platform independent, codec-agnostic and frame-accurate data transport mechanism.

With the non-image data 322 having been inserted into the non-image region 320, the modified frame 300 is further processed for downstream operations, such as compressed, collected with other similarly-processed frames into a set 340, and stored and/or conveyed downstream as will be described.

In this embodiment, process 90 is executed on one or more systems such as special purpose computing system 1000 shown in FIG. 2. Computing system 1000 may also be specially configured with software applications and hardware components to enable a user to author, edit and play media such as digital video, as well as to encode, decode and/or transcode the digital video from and into various formats such as MP4, AVI, MOV, WEBM and using a selected compression algorithm such as H.264 or H. 265 and according to various selected parameters, thereby to compress, decompress, view and/or manipulate the digital video as desired for a particular application, media player, or platform. Computing system 1000 may also be configured to enable an author or editor to form multiple copies of a particular digital video, each encoded with a respective bitrate, to facilitate streaming of the same digital video to various downstream users who may have different or time-varying capacities to stream it through adaptive bitrate streaming.

Computing system 1000 includes a bus 1010 or other communication mechanism for communicating information, and a processor 1018 coupled with the bus 1010 for processing the information. The computing system 1000 also includes a main memory 1004, such as a random access memory (RAM) or other dynamic storage device (e.g., dynamic RAM (DRAM), static RAM (SRAM), and synchronous DRAM (SDRAM)), coupled to the bus 1010 for storing information and instructions to be executed by processor 1018. In addition, the main memory 1004 may be used for storing temporary variables or other intermediate information during the execution of instructions by the processor 1018. Processor 1018 may include memory structures such as registers for storing such temporary variables or other intermediate information during execution of instructions. The computing system 1000 further includes a read only memory (ROM) 1006 or other static storage device (e.g., programmable ROM (PROM), erasable PROM (EPROM), and electrically erasable PROM (EEPROM)) coupled to the bus 1010 for storing static information and instructions for the processor 1018.

The computing system 1000 also includes a disk controller 1008 coupled to the bus 1010 to control one or more storage devices for storing information and instructions, such as a magnetic hard disk 1022 and/or a solid state drive (SSD) and/or a flash drive, and a removable media drive 1024 (e.g., solid state drive such as USB key or external hard drive, floppy disk drive, read-only compact disc drive, read/write compact disc drive, compact disc jukebox, tape drive, and removable magneto-optical drive). The storage devices may be added to the computing system 1000 using an appropriate device interface (e.g., Serial ATA (SATA), peripheral component interconnect (PCI), small computing system interface (SCSI), integrated device electronics (IDE), enhanced-IDE (E-IDE), direct memory access (DMA), ultra-DMA, as well as cloud-based device interfaces).

The computing system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computing system 1000 also includes a display controller 1002 coupled to the bus 1010 to control a display 1012, such as an LED (light emitting diode) screen, organic LED (OLED) screen, liquid crystal display (LCD) screen or some other device suitable for displaying information to a computer user. In this embodiment, display controller 1002 incorporates a dedicated graphics processing unit (GPU) for processing mainly graphics-intensive or other highly-parallel operations. Such operations may include rendering by applying texturing, shading and the like to wireframe objects including polygons such as spheres and cubes thereby to relieve processor 1018 of having to undertake such intensive operations at the expense of overall performance of computing system 1000. The GPU may incorporate dedicated graphics memory for storing data generated during its operations, and includes a frame buffer RAM memory for storing processing results as bitmaps to be used to activate pixels of display 1012. The GPU may be instructed to undertake various operations by applications running on computing system 1000 using a graphics-directed application programming interface (API) such as OpenGL, Direct3D and the like.

The computing system 1000 includes input devices, such as a keyboard 1014 and a pointing device 1016, for interacting with a computer user and providing information to the processor 1018. The pointing device 1016, for example, may be a mouse, a trackball, or a pointing stick for communicating direction information and command selections to the processor 1018 and for controlling cursor movement on the display 1012. The computing system 1000 may employ a display device that is coupled with an input device, such as a touch screen. Other input devices may be employed, such as those that provide data to the computing system via wires or wirelessly, such as gesture detectors including infrared detectors, gyroscopes, accelerometers, radar/sonar and the like. A printer may provide printed listings of data stored and/or generated by the computing system 1000.

The computing system 1000 performs a portion or all of the processing steps discussed herein in response to the processor 1018 and/or GPU of display controller 1002 executing one or more sequences of one or more instructions contained in a memory, such as the main memory 1004. Such instructions may be read into the main memory 1004 from another processor readable medium, such as a hard disk 1022 or a removable media drive 1024. One or more processors in a multi-processing arrangement such as computing system 1000 having both a central processing unit and one or more graphics processing unit may also be employed to execute the sequences of instructions contained in main memory 1004 or in dedicated graphics memory of the GPU. In alternative embodiments, hard-wired circuitry may be used in place of or in combination with software instructions.

As stated above, the computing system 1000 includes at least one processor readable medium or memory for holding instructions programmed according to the teachings of the invention and for containing data structures, tables, records, or other data described herein. Examples of processor readable media are solid state devices (SSD), flash-based drives, compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of processor readable media, includes software for controlling the computing system 1000, for driving a device or devices to perform the functions discussed herein, and for enabling the computing system 1000 to interact with a human user (e.g., digital video author/editor). Such software may include, but is not limited to, device drivers, operating systems, development tools, and applications software. Such processor readable media further includes the computer program product for performing all or a portion (if processing is distributed) of the processing performed discussed herein.

The computer code devices of discussed herein may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

A processor readable medium providing instructions to a processor 1018 may take many forms, including but not limited to, non-volatile media, volatile media, and transmission media. Non-volatile media includes, for example, optical, magnetic disks, and magneto-optical disks, such as the hard disk 1022 or the removable media drive 1024. Volatile media includes dynamic memory, such as the main memory 1004. Transmission media includes coaxial cables, copper wire and fiber optics, including the wires that make up the bus 1010. Transmission media also may also take the form of acoustic or light waves, such as those generated during radio wave and infrared data communications using various communications protocols.

Various forms of processor readable media may be involved in carrying out one or more sequences of one or more instructions to processor 1018 for execution. For example, the instructions may initially be carried on a magnetic disk of a remote computer. The remote computer can load the instructions for implementing all or a portion of the present invention remotely into a dynamic memory and send the instructions over a wired or wireless connection using a modem. A modem local to the computing system 1000 may receive the data via wired Ethernet or wirelessly via Wi-Fi and place the data on the bus 1010. The bus 1010 carries the data to the main memory 1004, from which the processor 1018 retrieves and executes the instructions. The instructions received by the main memory 1004 may optionally be stored on storage device 1022 or 1024 either before or after execution by processor 1018.

The computing system 1000 also includes a communication interface 1020 coupled to the bus 1010. The communication interface 1020 provides a two-way data communication coupling to a network link that is connected to, for example, a local area network (LAN) 1500, or to another communications network 2000 such as the Internet. For example, the communication interface 1020 may be a network interface card to attach to any packet switched LAN. As another example, the communication interface 1020 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1020 sends and receives electrical, electromagnetic or optical signals that carry digital data streams representing various types of information.

The network link typically provides data communication through one or more networks to other data devices, including without limitation to enable the flow of electronic information. For example, the network link may provide a connection to another computer through a local network 1500 (e.g., a LAN) or through equipment operated by a service provider, which provides communication services through a communications network 2000. The local network 1500 and the communications network 2000 use, for example, electrical, electromagnetic, or optical signals that carry digital data streams, and the associated physical layer (e.g., CAT 5 cable, coaxial cable, optical fiber, etc.). The signals through the various networks and the signals on the network link and through the communication interface 1020, which carry the digital data to and from the computing system 1000, may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computing system 1000 can transmit and receive data, including program code, through the network(s) 1500 and 2000, the network link and the communication interface 1020. Moreover, the network link may provide a connection through a LAN 1500 to a mobile device 1300 such as a personal digital assistant (PDA) laptop computer, or cellular telephone.

Computing system 1000 may be provisioned with or be in communication with live broadcast/streaming equipment that receives and transmits, in near real-time, a stream of digital video content captured in near real-time from a particular live event and having already had the non-image data inserted and encoded as described herein.

Alternative configurations of computing system, such as those that are not interacted with directly by a human user through a graphical or text user interface, may be used to implement process 90. For example, for live-streaming and broadcasting applications, a hardware-based encoder may be employed that also executes process 90 to insert the non-image data as described herein, in real-time.

The electronic data store implemented in the database described herein may be one or more of a table, an array, a database, a structured data file, an XML file, or some other functional data store, such as hard disk 1022 or removable media 1024.

In this embodiment, a frame identifier insertion module may be used at the request of a user by digital video authoring/editing software. For example, a user working on a particular composition may trigger the execution of the frame identifier insertion module from within the composition by navigating to and selecting a menu item to activate it. This may be done at any time, such as during editing in order to preview the effect of events that are being associated with particular frames. The frame identifier insertion module may alternatively be activated during a publishing routine that may subsequently automatically encode the digital video, with inserted frame identifier, into one or more formats such as MP4, AVI, MOV, or WEBM.

The resolution of the images in the frames may be factored in the process of inserting non-image data. Such resolution information may be provided or may alternatively be gleaned from a frame of the digital video itself, simply by the frame identifier insertion module referring to the number of pixels being represented in memory both horizontally and vertically for the frames. A standard frame aspect ratio for an equirectangular image is 2:1 such that the number of pixels spanning the width of the frame is twice the number of pixels spanning its height. Other format aspect ratios are possible.

The resolution may be used by the frame identifier insertion module along with other parameters to determine the extent to which scaling-down can be done in order to insert an appropriate frame identifier into regions of the digital video.

In this embodiment, each frame identifier that is to be inserted into a frame by the frame identifier insertion module represents a number in a sequence that is represented in binary. Each digit in the binary code is represented by a respective block of uniformly-coloured pixels inserted into the formed one or more non-image region. For example, a rectangular block of black pixels may be used to represent a 0, and a rectangular block of red pixels may be used to represent a 1. Alternatives are possible. However the colours and intensities of the pixels in the blocks should be selected such that the frame identifiers they represent can withstand compression during encoding so as to be reliably discernable (i.e. machine-parsable) by a media player upon decoding. As such, one recommended approach is to, when selecting a colour using RGB channels, set each colour either at full intensity or at zero intensity. One, two or all three of the RGB channels can be used to select the colour of pixels in a block, though it will of course be understood that the colour chosen for a 0 bit cannot be the same as the colour chosen for the 1 bit.

In the event that compression is not being employed, or a particular form of compression that preserves even slight colour differences is being employed, a base other than binary may be successfully employed such that more than two (2) colours could represent bits. For example, to reduce screen real-estate taken up by a frame identifier, four (4) colours could be selected rather than two (2), such that each bit could take on one of four (4) values instead of one of two (2) values.

The position and size of the blocks of uniformly-coloured pixels representing bits of the binary code is also important. As for size, the block of uniformly-coloured pixels must be sized such that it substantially eliminates the block's colour from being unduly impacted (i.e. rendered unusable as a bit in a frame identifier) during compression while being encoded. As would be understood, a bit 2×2 pixels in size in a 4K-resolution frame would likely normally be considered unimportant by a compression algorithm, such that it would be subsumed during compression as another member of an 8×8 block of pixels in the neighborhood having a uniform colour corresponding to the majority of pixels in the block, or be subsumed within its surroundings in some other way such as through inter-frame motion compensation. As such, the size of the block of uniformly-coloured pixels representing each bit of the frame identifier should be such that the compression algorithm considers it a feature unto itself warranting careful handling during compression. For example, the block of colour should remain above 50% intensity of the chosen colour.

While large blocks are useful for withstanding compression during encoding, the size of the blocks should be balanced against the extent to which the image data can be scaled-down yet still provide satisfactory image quality during playback downstream by a media player. For the same reason, and also so that a media player can find the frame identifier in each frame that has one by processing the same memory regions (i.e. pixels) in each frame rather than consume processing resources searching around for it, the position of the block of uniformly-coloured pixels within the non-image region or regions is important.

In this embodiment, the scaling down (i.e., downscaling) S is a squeezing operation S, in which the pixels of the original-sized image data are mapped to respective positions in a smaller region within the frame. This may be done in a number of ways. For example, the resultant pixels in the smaller image data region may have one-to-one counterparts in the original-sized image data, whereas some of the pixels in the original-sized image data are not mapped to respective positions in the smaller region at all. That is, certain pixels are simply not mapped. As another example, the colour and intensity of each pixel in the smaller image data region may result from processing a plurality of pixels in the original-sized image data.

Various processes are known for scaling image data either to be smaller or to be larger downstream, including nearest neighbor interpolation, bilinear and bicubic algorithms, Lanczos resampling, and the like.

With the non-image region(s) having been formed at step 100, the non-image data in the form of frame identifier binary bits is inserted into the determined non-image region(s) of the frames. In this embodiment, this is done by automatically selecting another digital video—a frame identifier digital video—from a set of frame identifier digital videos. Each frame identifier digital video from which the selection is made is predefined to itself consist of frame identifiers for each frame in the frame identifier digital video, with the remainder of the frame being unpopulated with pixels. The selection of frame identifier digital video may be based on the determined resolution such that a frame identifier digital video is selected having frame identifiers sized and positioned appropriate to the resolution. The selected frame identifier digital video is overlaid atop the digital video into which frame identifiers are to be inserted thereby to form a composite digital video containing the frame identifiers. In this embodiment, the frame identifier digital videos are also further subdivided for each given resolution based on number of frames, such that a binary code having a number of bits appropriate to the length of video can be overlaid. In this way, the system can avoid overlaying a binary code that could accommodate a three (3) hour digital video when a binary code that accommodates the target 30-second digital video would suffice and would be faster for a media player to parse under the conditions.

The insertion of frame identifiers into frames is useful for frame-accurate event-triggering. Events are actions to be taken by a media player during playback of the digital video to enrich the playback experience for a user. One example of such an event is a forced perspective. With a forced perspective event, beginning with the frame having the frame identifier associated with a forced perspective event, the view of a user of the digital video is forced to a predetermined visual perspective. That is, the media player enacts a perspective switch to force the user to focus on a particular region of the video that is important for the narrative. This gives creators a vital tool for directing attention in a 360 video or in virtual reality, as examples.

Events can alternatively include one or more projection switches from flat to 360 video and vice-versa, live-rendering and display as well as removal of graphical objects placed over top of the digital video, the display and removal of subtitles, the display and removal of hyperlinked text, the triggering of sound events, the triggering of transmission of a signal for triggering an event on a different device, the triggering of a query to the user, the triggering of billing, the triggering of display of a particular advertisement or of an advertisement of a particular type, and the like. Other events can include programmatic visual effects such as fades and/or the use of faders, overlays rendered independently of the video itself, audio and/or spatial audio events, creation of interactive “regions” within the video that can be used to spawn additional elements or events. For example, after a video cut, a portion of the video such as a character may be made interactive and may be displayed as an overlaid graphic. Such events are planned by the author/editor, for example using the authoring software or using some other means, and are each represented by parameters that are stored in association with respective frame identifiers in a metadata file that is created during authoring/editing. In this way, the events may be triggered in conjunction with the frames in which the frame identifiers associated with the events are inserted. Such frames having corresponding events may be referred to as event-triggering frames.

The metadata file or a derivative of it is meant to accompany the digital video file when downloaded or streamed to a media player for playback, or may be located on the platform hardware hosting the media player. When accompanying the video file it could be included as part of a header of a video file. However, this approach would require re-rendering the video file in order to make modifications to the metadata and, where additional assets were required during event-triggering, such assets would have also to be tightly integrated in some way. Alternatively, when accompanying the video file the metadata file could simply have the same filename and path as the video file, with a different file extension, such that the media player could easily find and handle the two files in cooperation with each other. In this embodiment, the metadata file is in the form of an XML (eXtensible Markup Language) that is downloaded to the media player, parsed and represented in system memory as one or more events associated with a frame identifier that is/are to be triggered upon display of the decoded frame from which the corresponding frame identifier has been parsed. Alternatives in file format are contemplated, such as JSON (JavaScript Object Notation). Such a frame may be referred to as an event-triggering frame, and there may be many such event-triggering frames corresponding to one or more respective events to be executed by the media player.

In this embodiment, frame 400 having a frame identifier of 826 as described above is an event-triggering frame because there is a corresponding entry in the XML (or other format) metadata file representing an event to be triggered at frame number 826. In this embodiment, the event is a projection switch from a flat projection to a 360 projection wherein, beginning with the event-triggering frame 400 (frame number 826), the media player is to texture-map frames of the digital video to the predetermined spherical mesh in order to switch from presenting flat video to the user (in which the video has not been texture-mapped to a sphere), to presenting 360 video with a horizontal and vertical rotation of 0, as shown below:
<ProjectionSwitch id=“1” frame=“826” type=“VIDEO_360” hRot=“0” vRot=“0” fov=“65” enabled=“true” platform=“android” forceVRot=“TRUE” forceVR=“FALSE”/>

In this example, “fov” is the field of view of the virtual camera, “enabled” is a switch useful mainly during authoring and editing for indicating whether the Event is to actually occur, and “platform” indicates on which platform the event will be triggered. Where “platform” is concerned, it is the case that multiple platforms may all have the same event but may contain different parameter values based on what is most effective for that platform. For example, it is typically undesirable to at some point move the perspective of a user who is watching content on a virtual-reality display device such as a HMD because doing so can be disorienting, but on the other hand it can be advantageous to move the perspective of a user who is watching the same content on a non-virtual reality display. Other parameters include “forceVRot”, a switch to indicate whether the media player should force the vertical orientation when the event occurs, and “forceVR”, a switch to indicate whether the media player should force the orientation i.e. force perspective, in general when using a VR platform.

A later frame in the sequence of frames of the digital video may also be an event-triggering frame due to a corresponding entry in the XML (or other format) metadata file representing an event to be triggered at that later frame. For example, the event may be a projection switch from a 360 projection to a flat projection, wherein, beginning with the later event-triggering frame, the media player is to stop texture-mapping frames of the digital video to the predetermined spherical mesh in order to switch from presenting 360 video to the user to presenting flat video, as shown below:
<ProjectionSwitch id=“1” frame=“1001” type=“VIDEO_FLAT” hRot=“0” vRot=“0” fov=“65” enabled=“true” platform=“android” forceVRot=“TRUE” forceVR=“FALSE”/>

It will be appreciated that the frame identifiers in frames intended for flat video are placed by the decoder in the same non-image region position in processor-accessible memory as frame identifiers are placed in the equirectangular frames intended for 360 video. In this way, the media player can, subsequent to decoding, look to the same place in each frame for the frame identifiers.

With the digital video having been locked and having had frame identifiers inserted into non-image region(s) as described above, the digital video may be encoded using any number of a variety of appropriate codecs which apply compression and formatting suitable for network transmission and formatting for particular target audiences, media players, network capacities and the like.

A device appropriate for playback of a given digital video may take any of a number of forms, including a suitably-provisioned computing system such as computing system 1000 shown in FIG. 2, or some other computing system with a similar or related architecture. For example, the media player computing system may process the digital video for playback using a central processing unit (CPU) or both a CPU and a GPU, if appropriately equipped, or may be a hardware-based decoder. A media player computing system including a GPU would preferably support an abstracted application programming interface such as OpenGL for use by a media player application running on the computing system to instruct the graphics processing unit of the media player computing system to conduct various graphics-intensive or otherwise highly-parallel operations such as texture-mapping a frame to a predetermined spherical mesh for 360 video, as described in United States Patent Application Publication Nos. 2018/0005447 and 2018/0005449 both to Wallner et al. The media player may take the form of a desktop or laptop computer, a smartphone, virtual reality headgear, or some other suitably provisioned and configured computing device.

Various forms of computing system could be employed to play back video content in particular, such as head mounted displays, augmented reality devices, holographic displays, input/display devices that can interpret hand and face gestures using machine vision as well as head movements through various sensors, devices that can react to voice commands and those that provide haptic feedback, surround sound audio and/or are wearables. Such devices may be capable of eye-tracking and of detecting and receiving neural signals that register brain waves, and/or other biometric signals as inputs that can be used to control visual and aural representations of video content.

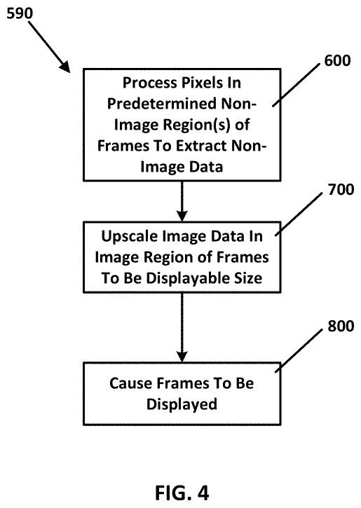

The XML (or other format) metadata file containing events to be triggered by the media player and other playback control data is made available for download in association with the encoded digital video file. In order to play back the digital video as well as to trigger the events, the media player processes the digital video file thereby to reconstruct the compressed frames of digital video and store the frames in video memory of the media player for further processing. Further processing conducted by the media player according to a process 590 as shown in FIG. 4 includes processing pixels in the frames to extract non-image data—in this embodiment frame identifiers identifying the sequential position of the frames—from the predetermined non-image regions of the frames in order to uniquely identify each frame (step 600). This is done by a software routine triggered by the media player that references the pixel values at locations in the memory corresponding to the pixels in the middle of the bits of the binary code. In this embodiment, due to compression the software routine reading the pixel values is required to accommodate for pixel colours that may be slightly off-white, or slightly off-black and so forth in order to be robust enough to accurately detect bit values and ultimately frame identifier values.

In this embodiment, in order to read these coloured blocks the effect of compression on colour is taken into account by assuming that any colour over 50% of 100% intensity is an accurate representation of the intended colour. As such, if a bit is 51% intensity of red, the block of colour is considered to be 1, or 100% intensity. On the other hand, if the colour is 49% intensity, the block is considered to be 0, or 0% intensity. Alternatives are possible, particularly where compression of colour is not very severe or in implementations where no compression is done.

In this embodiment, for processing a frame to extract a frame identifier prior to display by a media player, the i'th bit of the binary code (or whichever code is being employed for the frame identifier), may be determined by reading the values of pixels each positioned at X and Y locations within the non-image region of the frame according to Equations 2 and 3 below:

Pixel i X Location=BitPlacementOffset+(i*QuadSizeHorizontal)+(BitWidth*0.5) (2)

where: i>=0

Pixel i Y Location=BitHeight/2 (3)

Thereafter, the image data in the image region of the frame is subjected to mapping to expand the image region to a displayable size. That is, to be upscaled, in this embodiment de-squeezed (expanded), to a size appropriate for display (step 700). In this way, the frame is processed without adjusting its boundary size, such that the non-image data is not processed for display and downstream processes, such as displaying the image data, operate on the image data that had been carried within the frame.

In this embodiment, the upscaling operation S may be one of various known processes for upscaling image data, including nearest neighbor interpolation, bilinear and bicubic algorithms, Lanczos resampling, and the like. The upscaling operation may be, but is not required to be, the inverse of the downscaling operation that was used upstream to downscale the image data to form non-image regions.

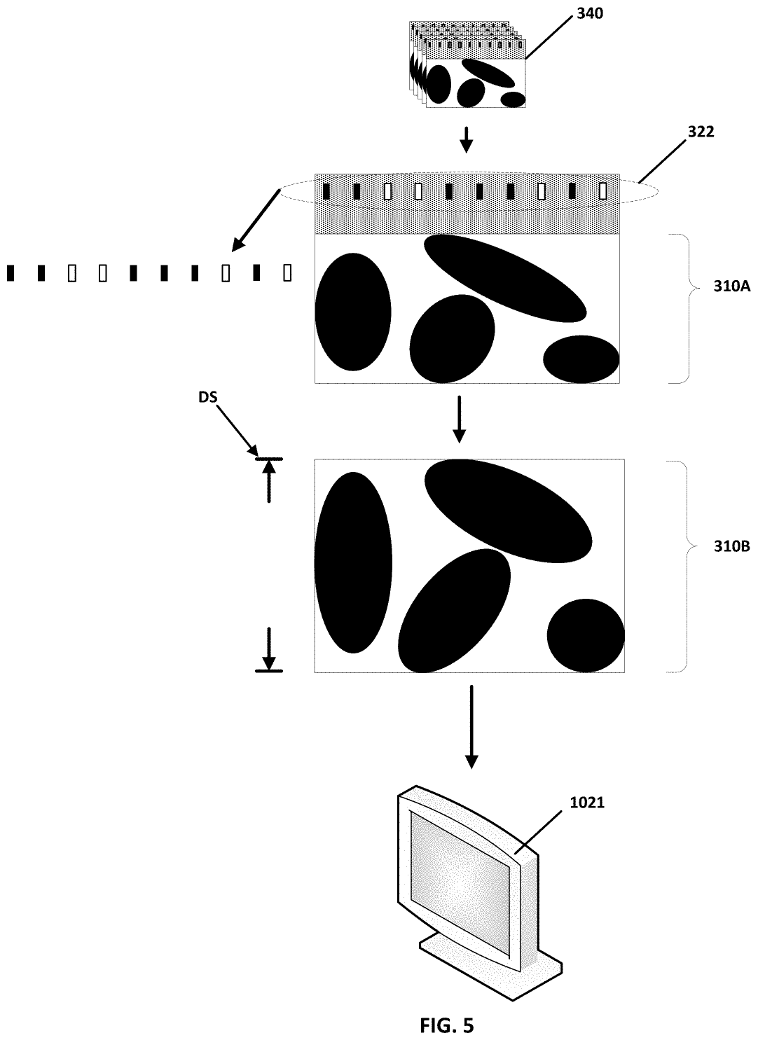

FIG. 5 is a diagram showing an example of non-image data 322 in a non-image region 320 of a frame 300 of (uncompressed) digital video 340 being extracted and then the image data 310A of the frame 300 being subjected to mapping to expand (in this embodiment “de-squeeze”) the image data 310B prior to display of the digital video. It will be noted that, for a given frame, the de-squeezed image data 310B results from a de-squeezing operation performed by, for example, a media player. As such, while the image data 310B will have an equivalent size to image data 310 (see FIG. 2) for a given frame, the actual pixel-by-pixel contents of image data 310B will not generally be equivalent to the actual pixel-by-pixel contents of image data 310. This is at least because image data 310B will be a downstream reconstruction based on image data 310A that is itself an approximation of image data 310. Furthermore, the processes of encoding and decoding the digital video are very likely to themselves contribute to various content differences as is well-known.

In accordance with any events in the XML (or other format) metadata file corresponding to the frame identifier that is extracted from the given frame being an event-triggering frame, any events are executed and the upscaled image data is inserted into the frame buffer RAM as a bitmap for display by the display device of the media player (step 800). An example of an event that may be executed prior to the display step is for the media player to texture-map a 360 video frame (specifically, the upscaled image data therein) to the predetermined spherical mesh such that the texture-mapped frame is caused to be displayed as explained above and in United States Patent Application Publication Nos. 2018/0005447 and 2018/0005449 both to Wallner et al. It will be understood that embodiments are possible in which texture-mapping and upscaling are combined operations rather than discrete sequential operations. For example, texture-mapping steps may account for the downscaled equirectangular image in the image region of the frame so as to map the downscaled image region directly to the predetermined geometry rather than upscale it beforehand. This would be appropriate, for example, for stereoscopic top-bottom 360 video frames, where the image data in each of the top and bottom halves is squeezed for placement within a single 16:9 frame, and could be further downscaled, for example squeezed horizontally, to additionally form a non-image region into which non-image data such as visual time codes could be inserted. Variations are possible.

Events associated with an event-triggering frame are triggered by the media player as the event-triggering frame is placed into the frame buffer. Elements such as graphical overlays that are triggered to be rendered by certain events are rendered in real-time and in sync with the digital video frames with which the events are associated.

Although embodiments have been described with reference to the drawings, those of skill in the art will appreciate that variations and modifications may be made without departing from the spirit, scope and purpose of the invention as defined by the appended claims.

For example, while embodiments described above involve inserting a frame identifier into all of the frames of a digital video prior to encoding, alternatives in which frame identifiers are inserted into only a subset of the frames of the digital video are contemplated. In such an alternative embodiment, only event-triggering frames and a threshold number of frames preceding the event-triggering frames in the sequence of frames may be provided with frame identifiers. The metadata file will specify events to be triggered upon display of an event-triggering frame, but the media player will be spared from having to parse each and every frame for a frame identifier. Instead, the media player will estimate the frame using elapsed time in a known manner, but upon approaching the elapsed time approximating the event-triggering frame, the media player can switch to processing frames to extract frame identifier data from the determined regions. In this way, the media player can trigger events with frame-accuracy without having the burden of parsing each and every frame for a frame identifier. After the event has been triggered, the media player can revert to estimating the frame using elapsed time until approaching the time that another event is to be triggered thereby to revert again to parsing frames expected to have a frame identifier.

In an alternative embodiment, whether or not all frames of the digital video have had frame identifiers inserted therein, the media player can operate to parse frame identifiers only from a few frames expected (by estimation using the codec-produced elapsed time timecode) to be preceding the event-triggering frame and the event-triggering frame itself.

In embodiments described above, the data inserted into the determined regions of frames are frame identifiers. In alternative embodiments, such frame identifiers may be represented in ways other than using binary codes. For example, for non-lossy encoding or low-compression encoding, where details of frame identifiers can be better preserved, other symbols such as two-dimensional barcodes may be employed as frame identifiers.

In further alternative embodiments, the data inserted into the determined regions of frames can include other kinds of data either in combination with the frame identifiers or instead of frame identifiers. For example, some of the data may be for error correction, such as parity bits and the like, thereby to enable the parser to verify the frame identifiers. In an embodiment, such alternative data may be digital rights management data, country code data, production source data, or instructions for triggering selection by a media player of a different accompanying XML (or other format) metadata file depending on some condition pertaining to the media player, such as its physical location for purposes of geoblocking or display of overlays in different languages or the like.

In embodiments described above, a frame identifier digital video is selected based on the determined resolution and length of digital video for forming, along with the digital video into which frame identifiers are to be inserted, a composite video. In alternative embodiments, there may be provided for selection only one frame identifier digital video for each resolution, such that the maximum number of bits ever required are used, even if the digital video with which it forms the composite would only ever make use of the least significant bits due to it being a short digital video.

Furthermore, rather than a frame identifier digital video being selected for forming a composite digital video, a script may be executed to, based on the resolution and the predetermined spherical mesh, dynamically overlay the frame identifiers (and/or other data after non-image region(s) is (are) formed) by modifying pixels within the determined regions of the digital video. In this way, the inserted data could be dynamically resealed based on a selected resolution adjustment, rather than requiring the pre-creation of a particular appropriate frame identifier digital video for that resolution. In a similar manner, the number of bits could be adapted based on the length of the digital video.

In embodiments described above, a non-image region 320 is formed at the top of a frame 300, with the image region 330 being below the non-image region 320. However, alternatives are possible. For example, a non-image region could be formed at the left side, at the right side, or at the bottom of the frame 300. The media player would be instructed to extract non-image data according to where the non-image region was located in a frame 300. Furthermore, multiple non-image regions could be formed, such as both at the top and bottom of a frame 300, by downscaling the image data into the middle of the frame. Alternatively, image data could be downscaled both horizontally and vertically, so as to form non-image regions of various configurations, depending on the need to include more and more non-image data in the frames and the limits of the extent to which downscaling of the image data could be done while still enabling satisfactory image quality upon upscaling/mapping. Still further, downscaling could be conducted non-linearly, such as by squeezing the top and/or bottom content more than the middle content thereby to preserve a higher resolution in the middle of the frame and sacrifice a little bit more resolution in the top or bottom of the frame.

In embodiments described above, the non-image data inserted into a frame is a frame-accurate timecode that may have a counterpart event stored in a metadata file with parameters for causing the media player to trigger a particular event upon the display of the frame. However, the non-image data inserted into the frame may be of a different nature. For example, the non-image data inserted into the frame may serve as direct instructions to the media player to take some particular action. Such non-image data may, for example, be a block of a particular colour of pixels that serve as direct instructions for the media player to, at the given frame, force a particular predetermined or instructed perspective onto the user thereby to focus on a particular region of the video that is important for a narrative. The media player would not have to consult an event list to be aware that it should execute the given event specified by the particular colour in the block. The colour itself could be used to specify parameters of such a perspective switch, such as location in the frame to which perspective should be changed. In another example, a different event such as a particular projection switch may be triggered using a block of a different particular colour of pixels such that the media player would not have to consult an event list to be aware that it should execute a projection switch from 360 to standard or vice versa at the given frame. Alternatively, such non-image data such as a block of a particular colour of pixels could be used to instruct the media player to take some other action.

Alternatively, where resolution and compression permit, the inserted data may be in the form of a one or two-dimensional barcode that encodes detailed instructions for triggering one or more events. Such a barcode may alternatively or in combination encode digital rights management information, and/or may encode instructions for the media player to trigger billing a user after a free preview period, and/or may encode instructions to display an advertisement, or may encode instructions to prompt the user as a trigger warning, and/or may encode instructions for the media player to take some other action not directly related to the user's direct experience during playback, such as logging the number of views of the digital video. Alternatives are possible.

In embodiments described herein, the frame identifier is inserted as non-image data into all frames. However, alternatives are possible. For example, in an alternative embodiment involving mapping some frames to a predetermined geometry and other being flat, it may be that all frames that are not to be mapped to a predetermined geometry may have non-image data inserted therein that does not represent a frame identifier but instead represents that the frame is not to be mapped, whereas frames that are to be mapped may have non-image data inserted therein that is different from the non-image data inserted into frames that are not to be mapped. Similarly, certain frames may have non-image data inserted therein that could be considered respective frame identifiers, but other frames in the digital video sequence could have no such non-image data inserted therein, or non-image data inserted therein that are not frame identifiers. Various combinations and combinations thereof are possible.

While in embodiment described above, frame-accurate timecodes are employed for triggering events to be executed during display of the digital video, alternatives are possible. One alternative includes the frame-accurate timecodes or other non-image data being employed to control whether or not multiple videos should be displayed at certain times or in addition or in sync with playback of a master video. In such an embodiment, the master video would carry the non-image data which is used either to synchronize independent videos to the master video or to define a range of time where independent videos can be displayed based on user interactivity. For example, a video could be produced that provides the experience of walking through the hall of a virtual shopping mall. As the user approached certain locations within the environment, advertisements could be displayed on the walls of the virtual shopping mall depending on when the user looked at them and depending on aspects of the user's personal profile. The advertisements would be present in videos being selected contextually based on the main video's content from a pool of available advertisement videos. The timecode in this example would not only define when to display an advertisement but also a range of time contextual to the main video environment. In another example, this methodology could be used to create events in a master video that react to users' actions and that are independent of the linear timeline of the video, by live compositing one or multiple pre-prepared video files into the master video. For example, the user might be in a room with a door, but the door opens only when the user looks at it. This may be achieved by compositing together two independent video files: the first being a main 360 frame of the entire room with the door closed and the second being a file containing a smaller independent video tile of the door opening that fits seamlessly into the main 360 frame in a manner that the resulting video appears to the user to be one video without seams. When the user looks at the door the video containing the action of the door opening is triggered independently of the timeline and is live-composited into the separate video of the entire room, thus making it appear that the door opened at the exact the time the user looked at it. Frame accurate timecodes would be essential in synchronizing the live compositing of such independent videos, which may have their own separate timecodes, to create complex sequences of asynchronous action triggered by the user in order to maintain the illusion of totally seamless interactivity for the user.

It has been found by the inventors through trial and error that, due to compression, digital video resolutions lower than 1280×640 are generally unable to support large enough frame identifier bit blocks to both maintain sufficient colour intensity during encoding while also being fully insertable into non-image regions. As would be understood, particular compression/decompression algorithms may be used that can preserve the frame identifier even at lower resolutions, should they exist and generally be available for use in codecs employed by media players. However, in an embodiment, a media player is provisioned to compensate where it is determined that frame identifier bit blocks cannot reliably be extracted from a particular digital video or stream thereof, or where it is determined that there are no frame identifier bit blocks in a particular segment of the digital video.

For example, in an embodiment, the media player is configured to monitor digital video quality throughout playback and, when the media player detects that frame quality has declined below a threshold level, the media player switches automatically from extracting frame identifiers from higher-quality frames as described above, to estimating the frame number using another technique. In an embodiment, the media player detects resolution of the last decoded frame. While the resolution detected by the media player remains above a threshold level (such as above 1280 pixels×640 pixels), the media player continues to extract frame identifiers from frames that incorporate them, as described above. However, should the media player detect that resolution has dropped below the threshold level—as might occur if the digital video is being transmitted using adaptive bitrate streaming in an uncertain network environment—the media player automatically switches over to estimating frame numbers based on elapsed time provided by the codec, and triggering any events associated with such frames based on the estimated frame number. The media player is also configured to continually or periodically monitor resolution and to switch back to extracting frame identifiers as described above, should the media player detect that the resolution of subsequent frames has risen again to or above the threshold level. As would be understood, this would be useful for enabling a media player to adapt in near real-time how it determines the frame number for triggering events, reverting to the most accurate technique whenever possible and as processing power permits. It will be understood that the media player may be configured to switch between extracting and an estimating technique or techniques not only based only on quality of the received digital video, but potentially based on other factors such as monitoring overall performance of a playback device or in response to a user configuring the media player to play back digital video with the minimum of processor involvement. The non-image data may be employed in various ways, such as disclosed in United States Patent Application Publication Nos. 2018/0005447 and 2018/0005449 both to Wallner et al.

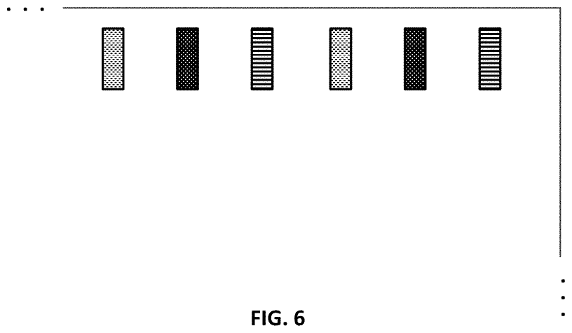

FIG. 6 is a diagram showing an embodiment of non-image data placed within a predetermined non-image region within a frame. It can be seen that there are two sets of three blocks of colour (depicted in black and white using fill patterns rather than actual colour for the purposes of this patent application). In this embodiment, a Red colour block would serve as an R bit and would have 100% intensity red colour. A Blue colour block would serve as a B bit and would have 100% intensity blue colour. A Green colour block would serve as a G bit and would have 100% intensity green colour.

In this embodiment, each of the sets of three is identical to each other so that the code represented by the first set of three is exactly the same as the code represented by the second set of three. In this way, the two sets are redundant and can therefore be read by a media player in order to significantly increase the confidence in detection of the code. This is because, while it is unlikely that image data captured or produced during filming or content production would duplicate a single set of the three colours in such a position, with particular spacing and the like, it is almost astronomically unlikely that two such sets would be so captured or produced. As such, the media player can, with very high confidence, detect the non-image data and recognize it is not a false positive. Additional sets of blocks of colours, or other techniques such as parity bits, Hamming codes, or the like, may similarly be used for this purpose.

The use of the blocks of colours as shown in FIG. 13 may be done independently of the insertion of frame identifiers, such that a particular sequence of colours always means to project a frame as a flat frame after cropping, and another sequence of colours means to conduct a forced perspective, or other events. A media player can be so instructed to detect a particular code and accordingly take some action, such as trigger a particular event, through use of data in a metadata file accompanying the digital video.

The concepts disclosed herein encompass various alternative formats of non-image data being included in the predetermined region or regions, such as a QR code or codes, barcodes, or other machine-readable non-image data useful in accordance with the principles disclosed herein.

1. A computer-implemented method of processing digital video, the method comprising:
for each of a plurality of selected frames of the digital video:
subjecting image data in the frame to scaling to occupy an image region that is smaller than the frame thereby to form at least one non-image region between the image region and the frame boundary; and
inserting non-image data into at least one non-image region formed by the scaling, the inserted non-image data being machine-readable for frame-accurate event-triggering.

2. The computer-implemented method of claim 1, wherein the non-image data comprises:
a frame identifier uniquely identifying each of the at least one selected frame.

3. The computer-implemented method of claim 1, wherein the non-image data comprises:
at least one instruction for a media player.

4. The computer-implemented method of claim 3, wherein the at least one instruction comprises:
an instruction for the media player to execute an event when the media player is displaying the selected frame.

5. The computer-implemented method of claim 4, wherein the event comprises:
a forced perspective wherein, beginning with the selected frame, the view is forced to a predetermined visual perspective.

6. The computer-implemented method of claim 4, wherein the instruction comprises event parameters.

7. The computer-implemented method of claim 1, wherein the non-image data comprises:
digital rights management data.

8. The computer-implemented method of claim 2, wherein each frame identifier comprises:
blocks of uniformly-coloured pixels, each block of uniformly-coloured pixels being coloured according to a value.

9. The computer-implemented method of claim 8, wherein each of the uniformly-coloured pixels has a maximum intensity.

10. The computer-implemented method of claim 8, wherein the number of blocks is correlated with a total number of frames in the digital video.

11. The computer-implemented method of claim 8, wherein the value of each block is either 0 or 1.

12. The computer-implemented method of claim 2, wherein inserting the non-image data comprises:
based at least on the resolution of the digital video, selecting a frame identifier digital video from a set of frame identifier digital videos, the selected frame identifier digital video comprising frames having respective frame identifiers positioned and dimensioned to correspond to the at least one non-image region; and
forming a composite video using the frame identifier digital video and the digital video.

13. The computer-implemented method of claim 12, wherein selecting the frame identifier digital video from a set of frame identifier digital videos is also based on the total number of frames of the digital video.

14. The computer-implemented method of claim 2, wherein inserting a respective frame identifier comprises:
based at least on the resolution of the digital video, executing a script to overlay respective frame identifiers onto the digital video in the at least one non-image region.

15. The computer-implemented method of claim 14, wherein the script overlays frame identifiers onto respective frames based on the total number of frames in the digital video.

16-26. (canceled)

27. A non-transitory processor readable medium embodying a computer program for processing digital video, the computer program comprising:
program code that for each of a plurality of selected frames of the digital video:
subjects image data in the frame to scaling to occupy an image region that is smaller than the frame thereby to form at least one non-image region between the image region and the frame boundary; and
inserts non-image data into at least one non-image region formed by the scaling, the inserted non-image data being machine-readable for frame-accurate event-triggering.

28. (canceled)

29. A system for processing digital video comprising processing structure in communication with a storage device storing processor-readable program code that, for each of a plurality of frames of the digital video:
causes the processing structure to subjects image data in the frame to scaling to occupy an image region that is smaller than the frame thereby to form at least one non-image region between the image region and the frame boundary; and
causes the processing structure to inserts non-image data into at least one non-image region formed by the scaling, the inserted non-image data being machine-readable for frame-accurate event-triggering.

30. (canceled)
